(19) United States
(12) Patent Application Publication
(10) Pub. No.: US 2026/0159255 A1
(43) Pub. Date: Jun. 11, 2026

(54) QUALITY ASSESSMENT AND SERVICE DAMAGE DETECTION FOR COMPOSITE DRIVE SHAFTS

(71) Applicant: Goodrich Corporation, Charlotte, NC (US)

(72) Inventors: Mark R. Gurvich, Middletown, CT (US); Jason M. Brosemer, Deerfield, NY (US); Brayton Reed, New York Mills, NY (US); Michael J. King, Sauquoit, NY (US); Michael Streeter, Mohawk, NY (US); Raymond H. Vollmer, Rome, NY (US); Jeffrey L. Mathis, Rome, NY (US); Douglas McNeil, Rome, NY (US)

(21) Appl. No.: 19/406,072

(22) Filed: Dec. 2, 2025

Related U.S. Application Data
(60) Provisional application No. 63/728,318, filed on Dec. 5, 2024.

(51) Int. Cl. B64F 5/60; B64C 27/06; B64C 27/14; B64C 27/82; B64D 35/00; B64D 45/00; B64D 47/08; B64F 5/40; G01N 21/88; G01N 21/952

(52) U.S. Cl. CPC B64F 5/60; B64C 27/06; B64C 27/14; B64C 27/82; B64D 35/00; B64D 45/00; B64D 47/08; B64F 5/40; G01N 21/8851; G01N 21/952; B64D 2045/0085

(57) ABSTRACT

A quality assessment method is provided and includes attaching a drive shaft (DS) to a transmission system, rotating the DS about a longitudinal axis thereof, infrared (IR) imaging of the DS during the rotating from a side of the DS, generating, from the IR imaging of the DS during the rotating, images of the DS including ring features appearing to extend circumferentially about the DS at longitudinal locations of local imperfections and assessing a quality of the DS from the images.

### CROSS-REFERENCE TO RELATED APPLICATIONS

This application claims the benefit of priority to U.S. Application No. 63/728,318 filed Dec. 5, 2024, the disclosure of which is incorporated herein by reference in its entirety.

### BACKGROUND

Exemplary embodiments of the present disclosure pertain to composite drive shafts and, in particular, to methods of quality assessment and service damage detection for composite drive shafts of aircraft, such as rotary-wing aircraft and helicopters or fixed-wing aircraft.

Aircraft drive shafts (DSs) are provided in drive systems of various types of aircrafts, such as rotary-wing aircrafts (e.g., helicopters) or fixed-wing aircrafts (e.g., airplanes). In a typical case of a rotary-wing aircraft, an aircraft DS is disposed within a helicopter to transmit engine torque and rotation from the helicopter engine at or near the main rotor, along the length of the helicopter body and the tail and to the intermediate gearbox at the end of the tail. An additional DS transmits the engine torque from the intermediate gearbox to the tail gearbox where the engine torque and rotation are used to drive rotations of the tail rotor.

### BRIEF DESCRIPTION

According to an aspect of the disclosure, a quality assessment method is provided and includes attaching a drive shaft (DS) to a transmission system, rotating the DS about a longitudinal axis thereof, infrared (IR) imaging of the DS during the rotating from a side of the DS, generating, from the IR imaging of the DS during the rotating, images of the DS including ring features appearing to extend circumferentially about the DS at longitudinal locations of local imperfections and assessing a quality of the DS from the images.

In accordance with at least one or more additional and/or alternative embodiments, the DS includes composite plies laid down in a predefined pattern and the composite plies include one or more of thermoplastic materials and thermoset materials, reinforced by carbon fibers, glass fibers and/or organic fibers and combinations thereof.

In accordance with at least one or more additional and/or alternative embodiments, the DS has one of a uniform diameter along an entire longitudinal length thereof and a non-uniform diameter along at least a portion of an entire longitudinal length thereof.

In accordance with at least one or more additional and/or alternative embodiments, the IR imaging is executed by an IR imaging system including an IR camera and the quality assessment method further comprises arranging the IR camera to face the side of the DS.

In accordance with at least one or more additional and/or alternative embodiments, the quality assessment method further includes applying one of a lateral and a longitudinal load to the DS during the rotating.

In accordance with at least one or more additional and/or alternative embodiments, the local imperfections include at least one of imperfect composite layup orientations, imperfect layup mutual arrangements, service damage and geometrical imperfections of DS shapes and the assessing of the quality of the DS from the images includes at least identifying the longitudinal locations of the local imperfections along an entire longitudinal length of the DS.

In accordance with at least one or more additional and/or alternative embodiments, the quality assessment method further includes automatically machining at least one or more of the local imperfections, wherein the automatically machining includes at least one of subtractive machining in an event any of the at least one or more of the local imperfections is an outwardly protruding imperfection and additive machining in an event any of the at least one or more of the local imperfections is an inwardly recessed imperfection.

In accordance with at least one or more additional and/or alternative embodiments, the quality assessment method further includes removing the DS from an aircraft prior to the attaching.

According to an aspect of the disclosure, an in-situ quality assessment method is provided for use with a drive shaft (DS) of an aircraft. The in-situ quality assessment method includes removing a portion of a cover structure of the aircraft to expose the DS, driving rotation of the DS about a longitudinal axis thereof at least at a sub-flight operation speed, infrared (IR) imaging of the DS during the rotating from a side of the DS, generating, from the IR imaging of the DS during the rotating, images of the DS including ring features appearing to extend circumferentially about the DS at longitudinal locations of local imperfections and assessing a quality of the DS from the images.

In accordance with at least one or more additional and/or alternative embodiments, the DS includes composite plies laid down in a predefined pattern and the composite plies include one or more of thermoplastic materials and thermoset materials, reinforced by carbon fibers, glass fibers and/or organic fibers and combinations thereof.

In accordance with at least one or more additional and/or alternative embodiments, the DS has one of a uniform diameter along an entire longitudinal length thereof and a non-uniform diameter along at least a portion of an entire longitudinal length thereof.

In accordance with at least one or more additional and/or alternative embodiments, the IR imaging is executed by an IR imaging system including an IR camera and the quality assessment method further includes arranging the IR camera to face the side of the DS via an opening formed by the removing of the portion of the cover structure of the aircraft.

In accordance with at least one or more additional and/or alternative embodiments, the local imperfections include at least one of imperfect composite layup orientations, imperfect layup mutual arrangements, service damage and geometrical imperfections of DS shapes and the assessing of the quality of the DS from the images includes at least identifying the longitudinal locations of the local imperfections along an entire longitudinal length of the DS.

In accordance with at least one or more additional and/or alternative embodiments, the quality assessment method further includes automatically machining at least one or more of the local imperfections via an opening formed by the removing of the portion of the cover structure of the aircraft, wherein the automatically machining includes at least one of subtractive machining in an event any of the at least one or more of the local imperfections is an outwardly protruding imperfection and additive machining in an event any of the at least one or more of the local imperfections is an inwardly recessed imperfection.

According to an aspect of the disclosure, an aircraft quality assessment assembly is provided and includes an infrared (IR) imaging system including an IR camera and an aircraft. The aircraft includes a cover structure, an engine, main and tail rotors rotatably drivable by the engine and a drive shaft (DS) by which torque and rotation are transmitted from the engine to the tail rotor. The IR camera is installed at a side of the DS within the cover structure. The IR imaging system and the IR camera are configured to generate, with the DS being rotated about a longitudinal axis thereof by the torque and rotation at least at a sub-flight operation speed, images of the DS including ring features appearing to extend circumferentially about the DS at longitudinal locations of local imperfections.

In accordance with at least one or more additional and/or alternative embodiments, the DS includes composite plies laid down in a predefined pattern and the composite plies include one or more of thermoplastic materials and thermoset materials, reinforced by carbon fibers, glass fibers and/or organic fibers and combinations thereof.

In accordance with at least one or more additional and/or alternative embodiments, the DS is a composite DS.

In accordance with at least one or more additional and/or alternative embodiments, the DS has a uniform diameter along an entire longitudinal length thereof.

In accordance with at least one or more additional and/or alternative embodiments, the DS has a non-uniform diameter along at least a portion of an entire longitudinal length thereof.

In accordance with at least one or more additional and/or alternative embodiments, the local imperfections include at least one of imperfect composite layup orientations, imperfect layup mutual arrangements, service damage and geometrical imperfections of DS shapes.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

The following descriptions should not be considered limiting in any way. With reference to the accompanying drawings, like elements are numbered alike:

FIG. 1 is a schematic diagram illustrating temperature growth due to hysteretic behavior of applied polymer matrix-based composite materials under cyclic load in a composite DS in accordance with embodiments;

FIGS. 2A, 2B and 2C are side schematic views of a DS with local imperfections in accordance with embodiments;

FIG. 3 is a flow diagram illustrating a quality assessment method in accordance with embodiments;

FIGS. 4A and 4B are side schematic views illustrating an execution of the quality assessment method of FIG. 3 in accordance with embodiments;

FIGS. 5A, 5B and 5C are side schematic views illustrating an execution of the quality assessment method of FIG. 3 and temperature non-uniformities in accordance with embodiments;

FIG. 6 is a side schematic views illustrating an execution of a quality assessment method with applied loads in accordance with embodiments;

FIG. 7 is a flow diagram illustrating an in-situ quality assessment method in accordance with embodiments;

FIGS. 8A and 8B are side views of an aircraft for which the in-situ quality assessment method of FIG. 7 is usable in accordance with embodiments; and

FIG. 9 is a side view of an aircraft including an IR camera installed in its tail boom in accordance with embodiments.

### DETAILED DESCRIPTION

A detailed description of one or more embodiments of the disclosed apparatus and method are presented herein by way of exemplification and not limitation with reference to the Figures.

In aerospace fields and, in particular, in rotorcraft or helicopters, DSs are used to transmit torque and rotation from one feature (i.e., an engine) to another (i.e., a tail rotor of a helicopter). Recently, polymer-matrix fiber-reinforced composite DSs have been introduced for this purpose. While a composite DS can provide significant weight reduction as compared to a conventional metallic DS, there are significant challenges associated with assessment of their quality, especially with respect to potential internal flaws, service damages and imperfections. Existing methods of quality assessment of composite structures to look for such flaws, damages and imperfections tend to require significant time, cost and labor resources. Their accuracy may depend on expertise of the personnel. They are also primarily focused on interlaminar damages and may miss some other imperfections, e.g., in-plane layup variability.

Thus, as will be described below, advanced inspection methods are provided and may be applied specifically for composite DSs. The advanced inspection methods provide labor and cost efficiency, enhanced convenience and increased accuracy to satisfy demands of expected mass production and frequent service of composite DSs.

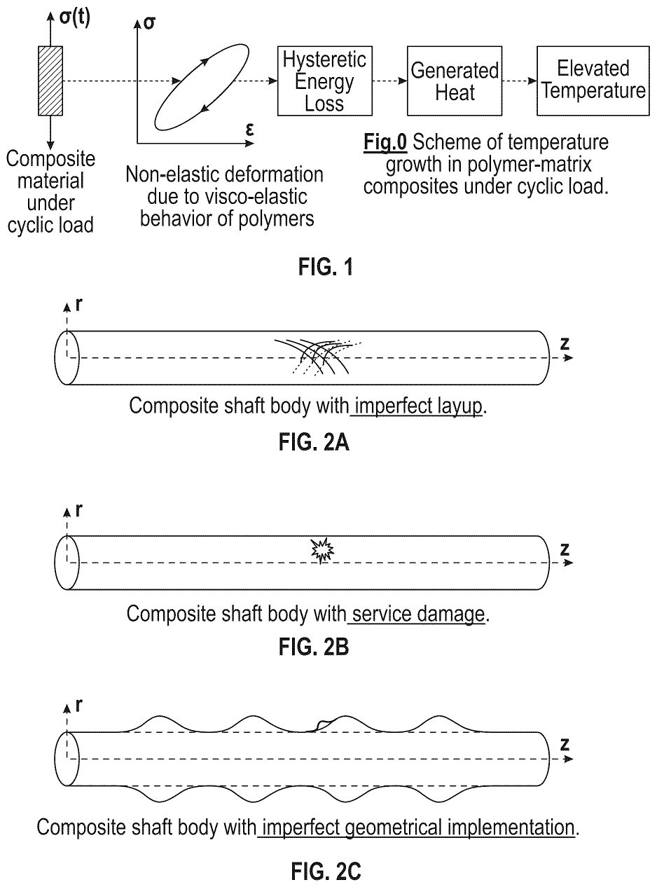

With reference to FIG. 1, the advanced inspection methods described herein are generally based on the visco-elastic nature of polymeric matrices of applied fiber-reinforced composite materials. Both thermoset and thermoplastic polymers are usually visco-elastic, and thermoplastic polymers are expected to be especially relevant to the proposed method due to their relatively high values of tan (δ), a key dimensionless parameter of visco-elasticity. Due to the visco-elastic nature of polymers, there is hysteretic energy loss under cyclic load. The energy loss per one cycle and per unit volume can be approximately quantified as area of a stress-strain hysteretic loop. The lost energy is expected to be primarily converted into heat according to the energy conversion law. The generated heat, therefore, is responsible for temperature growth during the cycling load. When the cyclic load is over, the temperature of the cyclically loaded part is gradually reduced to ambient temperature due to heat transfer processes. Therefore, it can be possible to monitor temperature distributions, including absolute values and relative non-uniformities, as indirect metrics of local stress/strain states, affected by either structural imperfections or service damages.

In the case of a composite DS under mainly dynamic (rotational) load conditions of torsional load transfer, uniform stress/strain distribution along the shaft length would be expected to show a generated heat and corresponding temperature profile that is correspondingly uniform along the shaft length and also in the hoop direction due to high-speed rotation. However, in case of local stress concentrations, some non-uniformity of temperature distributions can be expected. FIGS. 2A, 2B and 2C illustrate some reasons for such local stress concentrations and, therefore, pockets of excessive temperature: a) ply lay-up imperfections, b) service damages and c) geometrical imperfections, e.g., in shafts with noncylindrical shape, e.g., with coupling axisymmetric undulations.

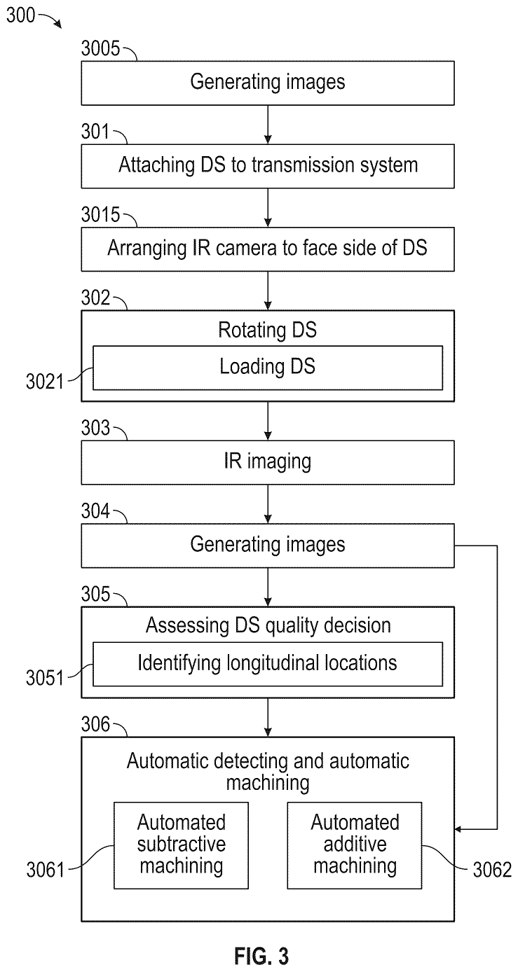

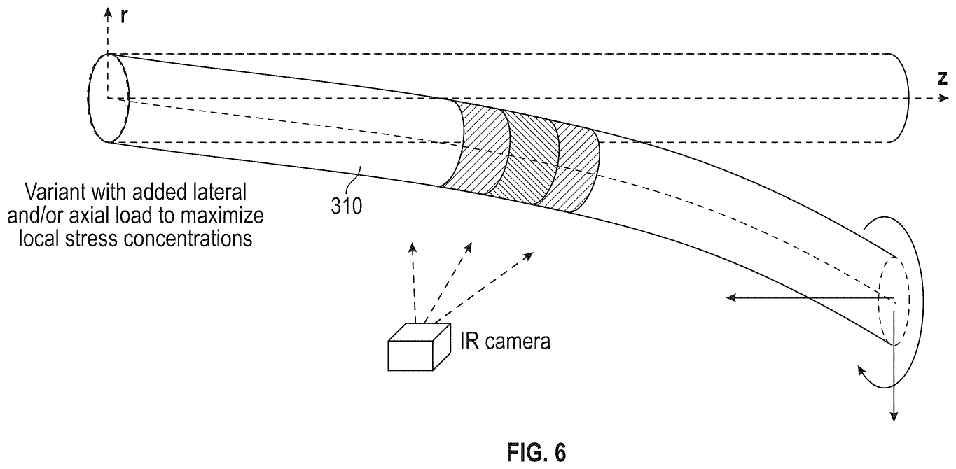

With reference to FIGS. 3-6, a quality assessment method 300 is provided. The quality assessment method 300 includes attaching a DS 310, such as a composite DS, to a transmission system (block 301), rotating the DS 310 about a longitudinal axis (axis z) thereof (block 302) by the transmission system, infrared (IR) imaging of the DS 310 during the rotating from a side of the DS 310 (block 303), generating, from the IR imaging of the DS 310 during the rotating, images 410, 411, 412 of the DS 310 including temperature ring features 4101, 4111, 4121 appearing to extend circumferentially about the DS 310 at longitudinal locations of local imperfections (block 304) and assessing a quality of the DS 310 from the images 410, 411, 412 (block 305). As shown in FIGS. 3 and 6, the quality assessment method 300 can further include applying one of a lateral load and/or a longitudinal load to the DS during the rotating of block 302 (block 3021).

It is to be understood that the DS 310 can be a DS of an aircraft, such as a rotorcraft or a helicopter, but can also be provided as a rotating shaft body for other similar purposes, e.g., for fixed-wing aircrafts. The following description will relate generally to the case of the DS 310 being a DS of an aircraft, such as a rotorcraft or a helicopter. This is for purposes of clarity and brevity, and should not be interpreted as limited the scope of the description or the following claims in any way.

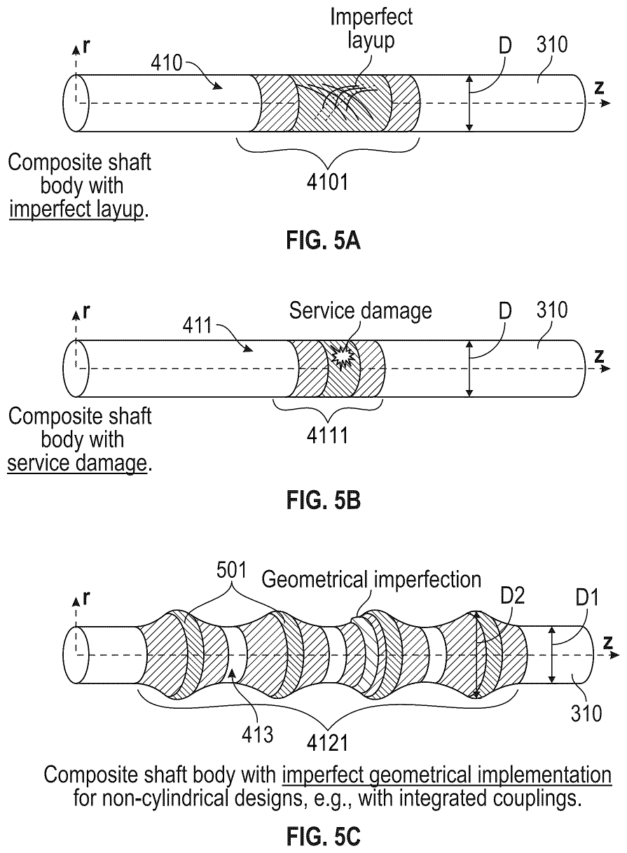

Especially in cases where the DS 310 is a composite DS, the DS 310 can include composite plies laid down in a predefined pattern (see FIG. 5A) and the composite plies can include one or more of thermoplastic materials and thermoset materials, where either of which can be reinforced by carbon fibers, glass fibers and/or organic fibers as well as various combinations thereof. As shown in FIGS. 5A and 5B, the DS 310 can have a uniform diameter D along an entire longitudinal length thereof. As shown in FIG. 5C, the DS 310 can have a non-uniform diameter D1, D2 (i.e., with undulations 501) along at least a portion of an entire longitudinal length thereof.

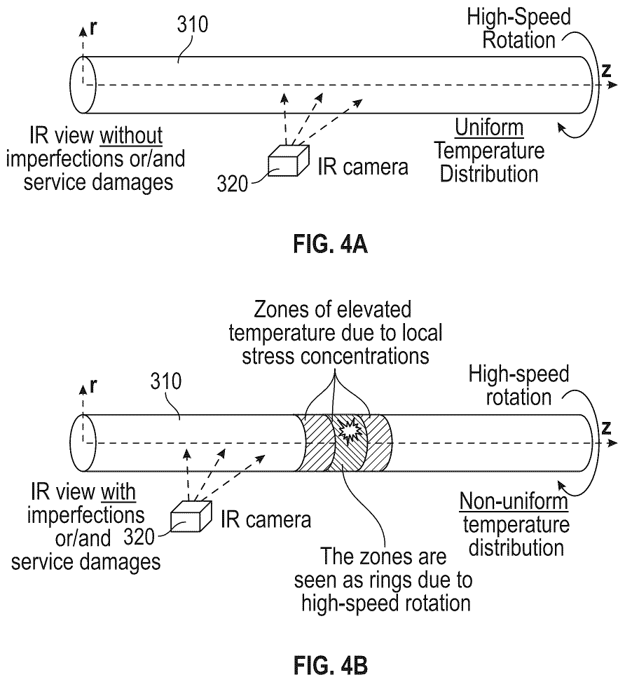

The IR imaging of block 303 can be executed by an IR imaging system including an IR camera 320 (see FIGS. 4A and 4B) and, in some cases, a control box or computing element disposed in signal communication with the IR camera 320. Where the IR imaging system includes the IR camera 320, the quality assessment method 300 of FIG. 3 further includes arranging the IR camera 320 to face the side of the DS 310 (block 3015).

As shown in FIGS. 4B, 5A, 5B and 5C, the local imperfections can include at least one of imperfect composite layup orientations and/or imperfect layup mutual arrangements as shown in FIG. 5A, service damage as shown in FIG. 5B and geometrical imperfections of DS shapes as shown in FIG. 5C. These local imperfections are observable in the images 410, 411, 412 as the ring features 4101, 4111, 4121, which are non-uniform temperature distributions manifesting in the hoop or circumferential direction of the DS 310. As such, the assessing of the quality of the DS 310 from the images 410, 411, 412 of block 305 can include at least identifying the longitudinal locations of the local imperfections along an entire longitudinal length of the DS 310 (block 3051).

In some cases in which the images 410, 411, 412 show the local imperfections, the quality assessment method 300 of FIG. 3 can further include automatically detecting and automatically machining at least one or more of the local imperfections (block 306) following the assessing of block 305 or directly/immediately following the generating of the images 410, 411, 412 of block 304. In these or other cases, the automatic detecting of block 306 can involve the use of artificial intelligence (AI) and modeling to identify the local imperfections from the images 410, 411, 412. Also, in these or other cases, the automatic machining of block 306 can include at least one of automated subtractive machining in an event any of the at least one or more of the local imperfections is an outwardly protruding imperfection such as the geometric imperfection of FIG. 5C (block 3061) and automated additive machining in an event any of the at least one or more of the local imperfections is an inwardly recessed imperfection such as the service damage of FIG. 5B (block 3062).

It is to be understood that the quality assessment method 300 of FIG. 3 can be applied to the DS 310 in a factory setting or following installation of the DS 310 in, for example, an aircraft, such as a rotorcraft or a helicopter. In the latter case, the quality assessment method 300 of FIG. 3 can further include removing or dis-installing the DS 310 from, for example, a tail boom of a rotorcraft or a helicopter prior to the attaching of the DS 310 to the transmission system of block 301 (block 3005).

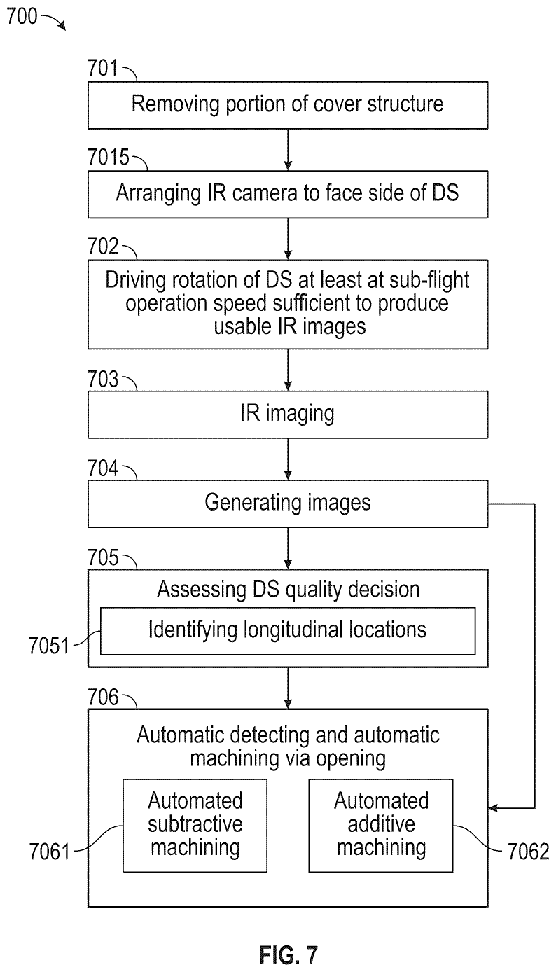

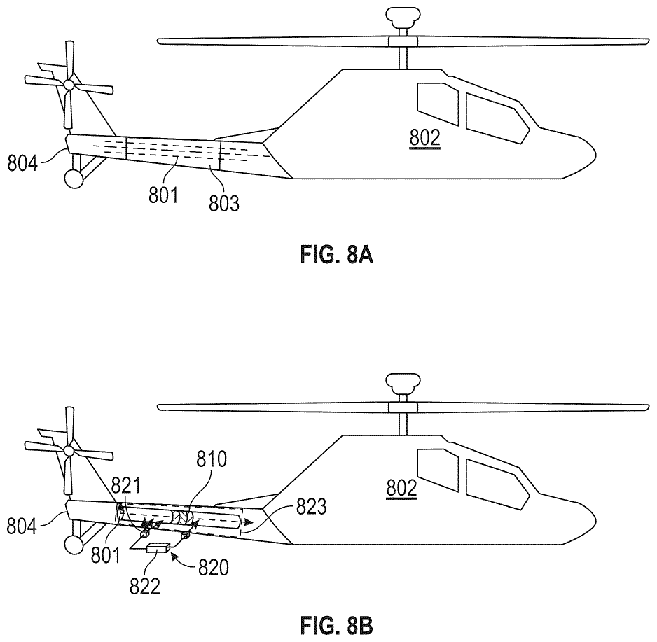

With reference to FIGS. 7, 8A and 8B, an in-situ quality assessment method 700 is provided for use with a DS 801 of an aircraft, such as a rotorcraft 802 or helicopter. The in-situ quality assessment method 700 is generally similar to the quality assessment method 300 of FIG. 3, and descriptions of elements of the in-situ quality assessment method 700 that overlap with those of the quality assessment method 300 of FIG. 3 are not necessary. The in-situ quality assessment method 700 includes removing a portion 803 of a cover structure 804 of the rotorcraft 802 to expose the DS 801 (block 701), driving rotation of the DS 801 about a longitudinal axis thereof at least at a sub-flight operation speed, which can be defined as a speed sufficient to produce usable IR images but less than necessary to generate thrust (block 702), IR imaging of the DS 801 during the rotating from a side of the DS 801 (block 703), generating, from the IR imaging of the DS 801 during the rotating, images of the DS 801 including ring features 810 appearing to extend circumferentially about the DS 801 at longitudinal locations of local imperfections as described above (block 704) and assessing a quality of the DS 801 from the images (block 705).

The IR imaging of block 703 can be executed by an IR imaging system 820 including an IR camera 821 (see FIG. 8B) and, in some cases, a control box or computing element 822 disposed in signal communication with the IR camera 821. Where the IR imaging system 820 includes the IR camera 821, the in-situ quality assessment method 700 of FIG. 7 further includes arranging the IR camera 821 to face the side of the DS 801 via an opening 823 formed by the removing of the portion of the cover structure 804 of block 701 (block 7015).

The local imperfections can include at least one of imperfect composite layup orientations, imperfect layup mutual arrangements, service damage and geometrical imperfections of DS shapes. These local imperfections are observable in the images as the ring features 810, which are non-uniform temperature distributions manifesting in the hoop or circumferential direction of the DS 801. As such, the assessing of the quality of the DS 801 from the images 810 of block 705 can include at least identifying the longitudinal locations of the local imperfections along an entire longitudinal length of the DS 801 (block 7051).

In some cases in which the images 810 show the local imperfections, the in-situ quality assessment method 700 of FIG. 7 can further include automatically detecting and automatically machining at least one or more of the local imperfections via the opening 823 formed by the removing of the portion of the cover structure 804 (block 706) following the assessing of block 705 or directly/immediately following the generating of the images block 704. In these or other cases, the automatic detecting of block 706 can involve the use of AI and modeling to identify the local imperfections from the images. Also, in these or other cases, the automatic machining of block 706 can include at least one of automated subtractive machining in an event any of the at least one or more of the local imperfections is an outwardly protruding imperfection such as a geometric imperfection (block 7061) and automated additive machining in an event any of the at least one or more of the local imperfections is an inwardly recessed imperfection such as service damage (block 7062).

To the extent that the in-situ quality assessment method 700 of FIG. 7 can only be applied to a section of the DS 801 corresponding to the location of the opening 823, it is to be understood that the in-situ quality assessment method 700 can be repeated at multiple locations along the longitudinal length of the DS 801 by removing different portions 803 of the tail 804.

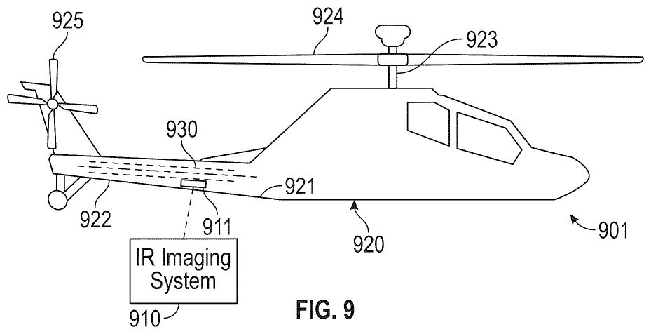

With reference to FIG. 9, an aircraft quality assessment assembly 901 is provided for executing quality assessments similar to those described above. The aircraft quality assessment assembly 901 includes an IR imaging system 910 that includes an IR camera 911 and am aircraft 920, such as a rotorcraft or a helicopter. The aircraft 920 includes an airframe or cover structure 921 with a tail boom 922, an engine 923, main and tail rotors 924, 925 that are rotatably drivable by the engine 923 and a DS 930 by which torque and rotation are transmitted from the engine 923 to the tail rotor 925. The IR camera 911 is installed at a side of the DS 930 within the portion of the cover structure 921 surrounding the tail boom 922. The IR imaging system 910 and the IR camera 911 are configured to generate, with the DS 930 being rotated about a longitudinal axis thereof by the torque at least at a sub-flight operation speed as defined above, images of the DS 930 including ring features appearing to extend circumferentially about the DS 930 at longitudinal locations of local imperfections.

The DS 930 can include composite plies laid down in a predefined pattern and the composite plies can include one or more of thermoplastic materials and thermoset materials, where either of which can be reinforced by carbon fibers, glass fibers and/or organic fibers as well as various combinations thereof. The DS 930 can be provided as a composite DS. The DS 930 can have a uniform diameter along an entire longitudinal length thereof or a non-uniform diameter (i.e., with undulations) along at least a portion of an entire longitudinal length thereof.

The local imperfections can include at least one of imperfect composite layup orientations, imperfect layup mutual arrangements, service damage and geometrical imperfections of DS shapes. These local imperfections are observable in the images as the ring features, which are non-uniform temperature distributions manifesting in the hoop or circumferential direction of the DS 930. As such, an assessing of a quality of the DS 930 from the images can be executed and can include at least identifying the longitudinal locations of the local imperfections along an entire longitudinal length of the DS 930.

Technical effects and benefits of the disclosure include reduced cost, labor and time in characterization of quality (and/or detection of service damages), increased accuracy in characterization of quality (and/or detection of service damage), opportunity to detect manufacturing imperfections, undetectable otherwise by other methods, opportunity to use low-level technicians without special training or multi-year expertise, simplicity of integration with fully- or semi-automated variants of this method with additional cost, labor, time and accuracy advantages, simplification of communication and resolving of disagreements with vendors and/or customers with respect to quality assessment, since the characterization results are objective, quantified and easily understood as well as licensing opportunities.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A quality assessment method, comprising:
attaching a drive shaft (DS) to a transmission system;
rotating the DS about a longitudinal axis thereof;
infrared (IR) imaging of the DS during the rotating from a side of the DS;
generating, from the IR imaging of the DS during the rotating, images of the DS including ring features appearing to extend circumferentially about the DS at longitudinal locations of local imperfections; and
assessing a quality of the DS from the images.

2. The quality assessment method according to claim 1, wherein:
the DS comprises composite plies laid down in a predefined pattern, and
the composite plies comprise one or more of thermoplastic materials and thermoset materials, reinforced by carbon fibers, glass fibers and/or organic fibers and combinations thereof.

3. The quality assessment method according to claim 1, wherein the DS has one of a uniform diameter along an entire longitudinal length thereof and a non-uniform diameter along at least a portion of an entire longitudinal length thereof.

4. The quality assessment method according to claim 1, wherein:
the IR imaging is executed by an IR imaging system comprising an IR camera, and
the quality assessment method further comprises arranging the IR camera to face the side of the DS.

5. The quality assessment method according to claim 1, further comprising applying one of a lateral and a longitudinal load to the DS during the rotating.

6. The quality assessment method according to claim 1, wherein:
the local imperfections comprise at least one of imperfect composite layup orientations, imperfect layup mutual arrangements, service damage and geometrical imperfections of DS shapes, and
the assessing of the quality of the DS from the images comprises at least identifying the longitudinal locations of the local imperfections along an entire longitudinal length of the DS.

7. The quality assessment method according to claim 1, further comprising automatically machining at least one or more of the local imperfections,
wherein the automatically machining comprises at least one of:
subtractive machining in an event any of the at least one or more of the local imperfections is an outwardly protruding imperfection; and
additive machining in an event any of the at least one or more of the local imperfections is an inwardly recessed imperfection.

8. The quality assessment method according to claim 1, further comprising removing the DS from an aircraft prior to the attaching.

9. An in-situ quality assessment method for use with a drive shaft (DS) of an aircraft, the in-situ quality assessment method comprising:
removing a portion of a cover structure of the aircraft to expose the DS;
driving rotation of the DS about a longitudinal axis thereof at least at a sub-flight operation speed;
infrared (IR) imaging of the DS during the rotating from a side of the DS;
generating, from the IR imaging of the DS during the rotating, images of the DS including ring features appearing to extend circumferentially about the DS at longitudinal locations of local imperfections; and
assessing a quality of the DS from the images.

10. The quality assessment method according to claim 9, wherein:
the DS comprises composite plies laid down in a predefined pattern, and
the composite plies comprise one or more of thermoplastic materials and thermoset materials, reinforced by carbon fibers, glass fibers and/or organic fibers and combinations thereof.

11. The quality assessment method according to claim 9, wherein the DS has one of a uniform diameter along an entire longitudinal length thereof and a non-uniform diameter along at least a portion of an entire longitudinal length thereof.

12. The quality assessment method according to claim 9, wherein:
the IR imaging is executed by an IR imaging system comprising an IR camera, and
the quality assessment method further comprises arranging the IR camera to face the side of the DS via an opening formed by the removing of the portion of the cover structure of the aircraft.

13. The quality assessment method according to claim 9, wherein:
the local imperfections comprise at least one of imperfect composite layup orientations, imperfect layup mutual arrangements, service damage and geometrical imperfections of DS shapes, and
the assessing of the quality of the DS from the images comprises at least identifying the longitudinal locations of the local imperfections along an entire longitudinal length of the DS.

14. The quality assessment method according to claim 9, further comprising automatically machining at least one or more of the local imperfections via an opening formed by the removing of the portion of the cover structure of the aircraft,
wherein the automatically machining comprises at least one of:
subtractive machining in an event any of the at least one or more of the local imperfections is an outwardly protruding imperfection; and
additive machining in an event any of the at least one or more of the local imperfections is an inwardly recessed imperfection.

15. An aircraft quality assessment assembly, comprising:
an infrared (IR) imaging system comprising an IR camera; and
an aircraft, comprising:
a cover structure;
an engine;
main and tail rotors rotatably drivable by the engine; and
a drive shaft (DS) by which torque and rotation are transmitted from the engine to the tail rotor,
the IR camera being installed at a side of the DS within the cover structure, and
the IR imaging system and the IR camera being configured to generate, with the DS being rotated about a longitudinal axis thereof by the torque and rotation at least at a sub-flight operation speed, images of the DS including ring features appearing to extend circumferentially about the DS at longitudinal locations of local imperfections.

16. The aircraft quality assessment assembly according to claim 15, wherein:
the DS comprises composite plies laid down in a predefined pattern, and
the composite plies comprise one or more of thermoplastic materials and thermoset materials, reinforced by carbon fibers, glass fibers and/or organic fibers and combinations thereof.

17. The aircraft quality assessment assembly according to claim 15, wherein the DS is a composite DS.

18. The aircraft quality assessment assembly according to claim 15, wherein the DS has a uniform diameter along an entire longitudinal length thereof.

19. The aircraft quality assessment assembly according to claim 15, wherein the DS has a non-uniform diameter along at least a portion of an entire longitudinal length thereof.

20. The aircraft quality assessment method according to claim 15, wherein the local imperfections comprise at least one of imperfect composite layup orientations, imperfect layup mutual arrangements, service damage and geometrical imperfections of DS shapes.
